(19) United States
(12) Patent Application Publication
(10) Pub. No.: US 2025/0363064 A1
(43) Pub. Date: Nov. 27, 2025

(54) UPDATING A WRITE-DONE POINTER IN A FIRST-IN-FIRST-OUT QUEUE ON A PARALLELIZED DEVICE

(71) Applicant: Microsoft Technology Licensing, LLC, Redmond, WA (US)

(72) Inventor: Jason Matthew GOULD, Woodinville, WA (US)

(21) Appl. No.: 19/095,457

(22) Filed: Mar. 31, 2025

Related U.S. Application Data
(60) Provisional application No. 63/650,283, filed on May 21, 2024.

(51) Int. Cl. G06F 13/16; G06F 9/30

(52) U.S. Cl. CPC G06F 13/1673; G06F 9/30021; G06F 13/1621

(57) ABSTRACT

Methods and systems for managing a first-in-first-out (FIFO) queue. A method includes receiving an end pointer and a done count from a producer. The method includes reading multiple values from memory: a checkpoint location in the FIFO queue, a count of data items marked complete before the checkpoint, an offset of the furthest location written to, and a total number of data items written. The method calculates new values for these parameters, and calculates a location within the FIFO queue prior to which all data has been written, and is therefore safe to consume. The method handles various forms of wrapping. This process ensures efficient tracking and management of data items within the FIFO queue, facilitating accurate and timely updates to the queue's state.

### CROSS-REFERENCE TO RELATED APPLICATIONS

This application claims priority to, and the benefit of, U.S. Provisional Application Ser. No. 63/650,283, filed on May 21, 2024, and titled “UPDATING A WRITE-DONE POINTER IN A FIRST-IN-FIRST-OUT QUEUE ON A PARALLELIZED DEVICE,” the entire contents of which are incorporated by reference here in their entirety.

### BACKGROUND

In computing, a first-in-first-out (FIFO) queue is a data structure that operates on the principle that the first element added to the queue will be the first one to be removed from the queue. This type of data structure has a variety of applications, including providing a buffer for the production and consumption of data. Managing FIFO queues in multi-threaded environments, in which multiple data producers may be writing to the FIFO queue at once, is complex because the order in which the various data producers allocate space within the FIFO queue will likely be different from the order in which that allocated space is filled by those producers. Thus, there is difficulty in knowing at which point in the FIFO queue it is safe for a consumer to read from the queue.

The subject matter claimed herein is not limited to embodiments that solve any disadvantages or that operate only in environments such as those described supra. Instead, this background is only provided to illustrate one example technology area where some embodiments described herein may be practiced.

### SUMMARY

First-in-first-out (FIFO) queues are often utilized in multi-producer environments-in which consumers (e.g., threads) read from the FIFO queue simultaneously with producers (e.g., threads) adding to it. When FIFO queues are utilized in this manner, care needs to be taken to track which portion of the FIFO queue has been entirely written to and is, therefore, safe to consume. In general, this means maintaining a “write done” pointer, referred to herein as a “WDonePtr,” that identifies a point in the FIFO queue at which all preceding data is guaranteed to have been written to the queue and, therefore, is safe to be consumed from the queue.

In some aspects, the techniques described herein relate to a method that facilitates maintenance of WDonePtr, implemented in a computer system that includes a processor system, including: receiving a plurality of values from a producer, including: receiving an end pointer value representing a pointer to an end of data the producer has finished writing into a first-in-first-out (FIFO) queue, and receiving a done count value indicating a number of data items the producer has finished writing into the FIFO queue; reading a plurality of memory values from a plurality of memory locations in a memory, including: reading a checkpoint value from a first memory location, the checkpoint value indicating a checkpoint location in the FIFO queue, reading a checkpoint write count value from a second memory location, the checkpoint write count value indicating a count of data items before the checkpoint location that have each been written and marked complete by any producer, reading a max written value from a third memory location, the max written value indicating an offset of a furthest location written to in the FIFO queue, and reading a count total value from a fourth memory location, the count total value indicating a total number of data items written to the FIFO queue; calculating a new checkpoint value, a new checkpoint write count value, a new max written value, and a new count total value, wherein: the new count total value is calculated as a sum of the count total value and the done count value; the new max written value is calculated as a maximum of the max written value and the end pointer value; when the end pointer value is less than the checkpoint value, the new checkpoint write count value is calculated as a sum of the done count value and the checkpoint write count value; or when all work in the FIFO queue prior to the checkpoint location in the FIFO queue indicated by the checkpoint value is completed, the new checkpoint value receives the new max written value and the new checkpoint write count value receives the new count total value; and updating the plurality of memory locations in the memory, including updating the first memory location with the new checkpoint value, updating the second memory location with the new checkpoint write count value, updating the third memory location with the new max written value, and updating the fourth memory location with the new count total value.

In some implementations, the method includes calculating a WDonePtr. In these implementations, the method includes determining a new write done pointer to be the new max written value when the new max written value is equal to the new count total value; or the checkpoint value when all work prior to the checkpoint location has been completed, and the end pointer value is less-than-or-equal-to the checkpoint value. In other implementations, the WDonePtr is calculated by the producer, e.g., based on one or more of the new and/or old values calculated by the method.

In some aspects, the techniques described herein relate to a processor system that includes an atomic instruction that facilitates maintenance of WDonePtr, and that, when executed: receives an end pointer value from a producer, the end pointer value representing a pointer to an end of data the producer has finished writing into a first-in-first-out (FIFO) queue; receives a done count value from the producer, the done count value indicating a number of data items the producer has finished writing into the FIFO queue; reads a plurality of values from a memory, including: reading a checkpoint value from a first memory location, the checkpoint value indicating a checkpoint location in the FIFO queue, reading a checkpoint write count value from a second memory location, the checkpoint write count value indicating a count of data items before the checkpoint location that have each been written and marked complete by any producer, reading a max written value from a third memory location, the max written value indicating an offset of a furthest location written to in the FIFO queue, and reading a count total value from a fourth memory location, the count total value indicating a total number of data items written to the FIFO queue; calculates a new checkpoint value, a new checkpoint write count value, a new max written value, and a new count total value, wherein: the new count total value is calculated as a sum of the count total value and the done count value; the new max written value is calculated as a maximum of the max written value and the end pointer value; when the end pointer value is less than the checkpoint value, the new checkpoint write count value is calculated as a sum of the done count value and the checkpoint write count value; or when all work in the FIFO queue prior to the checkpoint location in the FIFO queue indicated by the checkpoint value is completed, the new checkpoint value receives the new max written value and the new checkpoint write count value receives the new count total value; and updates the memory, including updating the first memory location with the new checkpoint value, updating the second memory location with the new checkpoint write count value, updating the third memory location with the new max written value, and updating the fourth memory location with the new count total value.

In some aspects, the techniques described herein relate to a computer system that facilitates maintenance of WDonePtr, including: a memory; and a processor system that includes an atomic instruction that, when executed: receives an end pointer value from a producer, the end pointer value representing a pointer to an end of data the producer has finished writing into a first-in-first-out (FIFO) queue; receives a done count value from the producer, the done count value indicating a number of data items the producer has finished writing into the FIFO queue; reads a checkpoint value from a first memory location, the checkpoint value indicating a checkpoint location in the FIFO queue; reads a checkpoint write count value from a second memory location, the checkpoint write count value indicating a count of data items before the checkpoint location that have each been written and marked complete by any producer; reads a max written value from a third memory location, the max written value indicating an offset of a furthest location written to in the FIFO queue; reads a count total value from a fourth memory location, the count total value indicating a total number of data items written to the FIFO queue; calculates a new checkpoint value, a new checkpoint write count value, a new max written value, and a new count total value, wherein: the new count total value is calculated as a sum of the count total value and the done count value; the new max written value is calculated as a maximum of the max written value and the end pointer value; when the end pointer value is less than the checkpoint value, the new checkpoint write count value is calculated as a sum of the done count value and the checkpoint write count value; or when all work in the FIFO queue prior to the checkpoint location in the FIFO queue indicated by the checkpoint value is completed, the new checkpoint value receives the new max written value and the new checkpoint write count value receives the new count total value; updates the first memory location with the new checkpoint value; updates the second memory location with the second checkpoint write count value; updates the third memory location with the third new value; and updates the fourth memory location with the fourth new value.

In some implementations, the atomic instruction calculates a WDonePtr. In these implementations, the atomic instruction determines a new write done pointer to be the new max written value when the new max written value is equal to the new count total value; or the checkpoint value when all work prior to the checkpoint location has been completed, and the end pointer value is less-than-or-equal-to the checkpoint value. In other implementations, the WDonePtr is calculated by the producer, e.g., based on one or more of the old and/or new values calculated by the atomic instruction.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates updating a write-done pointer in a first-in-first-out queue on a parallelized device;

FIG. 2 illustrates an example of updating a write-done pointer and a checkpoint in a first-in-first-out (FIFO) queue;

FIGS. 3A and 3B illustrate an example of the data and operations of an atomic instruction; and

FIG. 4 illustrates a flow chart of an example of a method for updating a write-done pointer in a FIFO queue on a parallelized device.

### DETAILED DESCRIPTION

Several approaches exist for managing first-in-first-out (FIFO) queues in multi-producer environments—in which consumers (e.g., threads) read from the FIFO queue simultaneously with producers (e.g., threads) adding to it. Each approach tracks which portion of the FIFO queue is safe to consume, for example, because that portion has been entirely written to.

A first approach tracks producers using a single bit per producer, where each producer toggles its corresponding bit when it has completed a write, indicating completion of the write. Then, the bits can be counted, and the first one that is not set can be used to update a “write done” pointer, referred to herein as a “WDonePtr,” for the FIFO queue. The WDonePtr identifies a point in the FIFO queue at which all preceding data is guaranteed to have been written to the queue and, therefore, is safe to be consumed from the queue. However, the overheads of this first approach (e.g., memory usage, memory reads, memory writes, computation) increase as the number of producers increases and the size of the FIFO queue increases.

A second approach subdivides the FIFO queue into regions, such as 64-kilobyte chunks (though the chunk size could vary). Then, the second approach tracks the furthest entry written to in a given region and the number of entries written in that region. If those two values are equal, writing to the region is complete, and that region is safe to consume up to the indicated point. The second approach is more efficient than the first, but it still requires many memory reads and writes and traversing of tracking pointers.

A third approach tracks a single global count of the last entry written in a FIFO queue and the number of entries written up to that point. If those two values are the same, the third approach updates a WDonePtr.

While these approaches may be manageable when there are relatively few simultaneous producers (e.g., tens of producers, at most), they break down on highly parallelized devices, such as modern central processing units (CPUs) (where there can be hundreds of hardware threads all running simultaneously) or graphics processing units (GPUs) (where there may be tens of thousands, or even to hundreds of thousands, of threads all executing simultaneously). For example, the memory overheads of the first and second approaches become unmanageable as the FIFO queue sizes grow; and computational and bandwidth overheads of the first and second approaches quickly become inefficient as the number of producer threads increases into thousands or more. Under the third approach, as the number of producer threads increases, the likelihood of there being a point where all data up to the last piece of data has been written decreases, so there can be situations in which it is never considered safe to consume from the FIFO queue until all producer work has completed. Thus, the third approach quickly becomes unpredictable, or at worst non-functional with more than a few hundred simultaneous producers.

The embodiments described herein include novel methods and systems for continually updating a WDonePtr for a FIFO queue, which remain functional and performant even in the presence of tens to hundreds of thousands of producers. These embodiments include a new form of atomic instruction implemented in the hardware, such as a GPU, a method of preparing data to feed into the atomic instruction, and steps after executing the atomic instruction, leading to updating a WDonePtr.

These embodiments guarantee frequent updates to a WDonePtr using one or two atomic instructions for each update. In contrast, the prior approaches either do not update a WDonePtr frequently enough (resulting in times when a consumer cannot consume anything despite data being present in the FIFO queue) or require computationally costly contentious loops over multiple counters or arrays of tracking bits. Due to their hardware implementation, the atomic instruction(s) described herein can be dramatically faster than any prior approach, particularly as the number of producers increases.

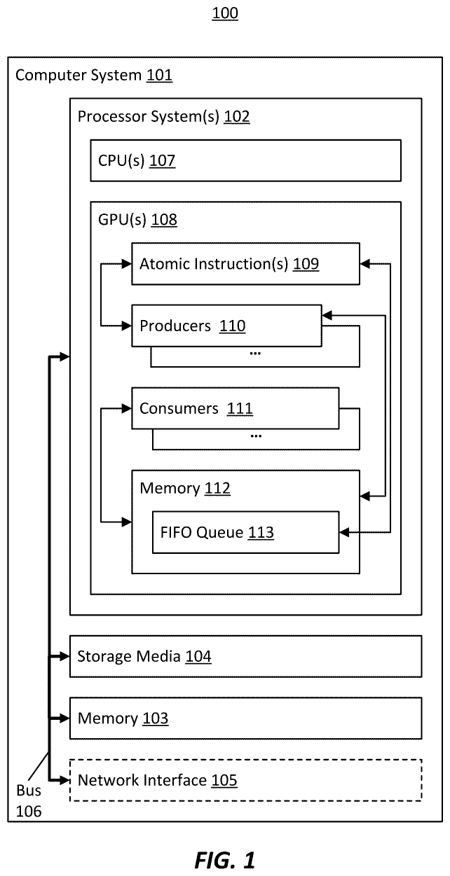

FIG. 1 illustrates an example of a computer system 100 that facilitates updating a WDonePtr in a first-in-first-out queue on a parallelized device. In FIG. 1, computer system 100 comprises one or more processor systems 102 (e.g., one or more CPUs, one or more GPUs, one or more neural processing units), a memory 103 (e.g., system or main memory), and a storage medium 104 (e.g., a single computer-readable storage medium or a plurality of computer-readable storage media), all interconnected by a bus 106. As shown, computer system 101 may include hardware such as a network interface 105 (e.g., one or more network interface cards) for interconnecting to other computer systems via a network.

In FIG. 1, the processor system 102 includes a CPU 107 and a GPU 108. In some embodiments, GPU 108 and CPU 107 are integrated (e.g., into the same die or package). In other embodiments, CPU 107 and GPU 108 are discrete components. As shown, GPU 108 includes atomic instruction(s) 109, a plurality of producers 110 (e.g., shader threads), a plurality of consumers 111 (e.g., shader threads), and a memory 112 storing a FIFO queue 113. As indicated by arrows, producers 110 and consumers 111 interact with memory 112, including with FIFO queue 113 (e.g., writing to FIFO queue 113 in the case of producers 110 and reading from FIFO queue 113 in the case of consumers 111). Although not shown, producers 110 and/or consumers 111 may also interact with memory 103. Additionally, an arrow shows that producers 110 can interact with FIFO queue 113 via atomic instruction(s) 109.

In some examples, each producer of producers 110 has four general responsibilities:
1. Allocating a portion of FIFO queue 113 to write its data,
2. Calculating and writing the data to FIFO queue 113,
3. Ensuring data is visible to potential consumers, and
4. Potentially, updating a WDonePtr, indicating that all work up to that point has been contiguously written into FIFO queue 113 (e.g., with no gaps).

For the first responsibility, the producer allocates a portion of FIFO queue 113 for writing its data. To do so, the producer may need to calculate how much of the FIFO queue 113 the producer needs to allocate. In examples, the FIFO queue 113's sizes and indices can represent its size in terms of bytes, words (e.g., 32-bit values), or some arbitrary fixed-size element. In embodiments, allocating a portion of FIFO queue 113 can be done with an atomic “add” instruction. Alternatively, if allocation sizes are known beforehand, a single coordination thread can subdivide FIFO queue 113 and pass the producer a pointer to use (e.g., as the producer is launched). Either way, the producer gets a pointer, and it operates with the instruction of how many elements it writes at some point.

For the second responsibility, the producer uses this pointer to write data into the FIFO queue 113.

For the third responsibility, the producer waits for the writes to be acknowledged (e.g., by a memory controller), guaranteeing that the writes are visible to any potential consumer of consumers 111. This may sometimes require a cache flush (e.g., forcing written data out of a local cache into a memory controller) and/or waiting for the memory controller to acknowledge receipt of writes and/or flushes.

The embodiments herein provide an atomic instruction for carrying out the fourth responsibility. In embodiments, a producer (e.g., a shader in GPU 108) calls an atomic instruction (e.g., instruction(s) 109) after that producer has written to some number, N, of contiguous data elements (e.g., starting at offset J, and including J+1, J+2, . . . J+N−1) to a FIFO queue (e.g., FIFO queue 113). In embodiments, the atomic instruction takes, as input, two values provided by the producer when calling the atomic instruction. In embodiments, these two values include:
1. PrEnd (producer end): an index or pointer to a location in the FIFO queue immediately following the data just appended to the FIFO queue by the producer (e.g., N+J), and
2. PrCount (producer count): a count of bytes or elements written by the producer (e.g., N).
   In some embodiments, at least one bit of PrEnd (e.g., a “high,” or most significant, bit) indicates the number of times the FIFO queue has wrapped from the end of the FIFO queue to the beginning of the FIFO queue (e.g., in the case in which the FIFO queue is implemented as a circular buffer). In embodiments, these two values are each 32-bit words, though they could be implemented as larger or smaller values (e.g., 16-bit values, 64-bit values).

In embodiments, the atomic instruction also takes, as input, four values, each located in memory (e.g., memory 103, memory 112). In embodiments, these memory locations are provided to the atomic instruction as a memory address at which the four values are stored contiguously. In embodiments, each value is also a 32-bit word, though they could be implemented as larger or smaller values (e.g., 16-bit values, 64-bit values). In embodiments, these four values include:
1. MaxWritten (max written): an offset of the furthest location written in the FIFO queue.
2. CountTotal (count total): the total number of data items written to the FIFO queue,
3. CheckpointEnd (checkpoint end): an offset of a “checkpoint” location in a FIFO queue, and
4. CpCountWritten (checkpoint count written): a count of data items before that checkpoint that have each been written and marked complete by any producer.

In embodiments based on these inputs, the atomic instruction updates the four values in memory (e.g., MaxWritten, CountTotal, CheckpointEnd, CpCountWritten) and returns a value (e.g., WDonePtr) to the producer that called the atomic instruction.

In embodiments, every time a producer completes work, it executes the atomic instruction, which updates the MaxWritten, the CountTotal. If the work item is prior to the CheckpointEnd, the atomic instruction also updates the CpCountWritten. When all work items prior to the CheckpointEnd are completed, the atomic instruction replaces CheckpointEnd and CpCountWritten with the new MaxWritten and new CountTotal, respectively.

In embodiments, whenever the CheckpointEnd moves, WDonePtr is updated. WDonePtr takes on the value of the old CheckpointEnd, or if all work prior to the new MaxWritten is done, WDonePtr takes on the new MaxWritten value. Notably, while updates to CheckpointEnd and MaxWritten, and the copy from MaxWritten to CheckpointEnd are performed atomically, updates to the WDonePtr can be performed simultaneously as part of the same atomic, or they can be done later with a separate atomic max instruction.

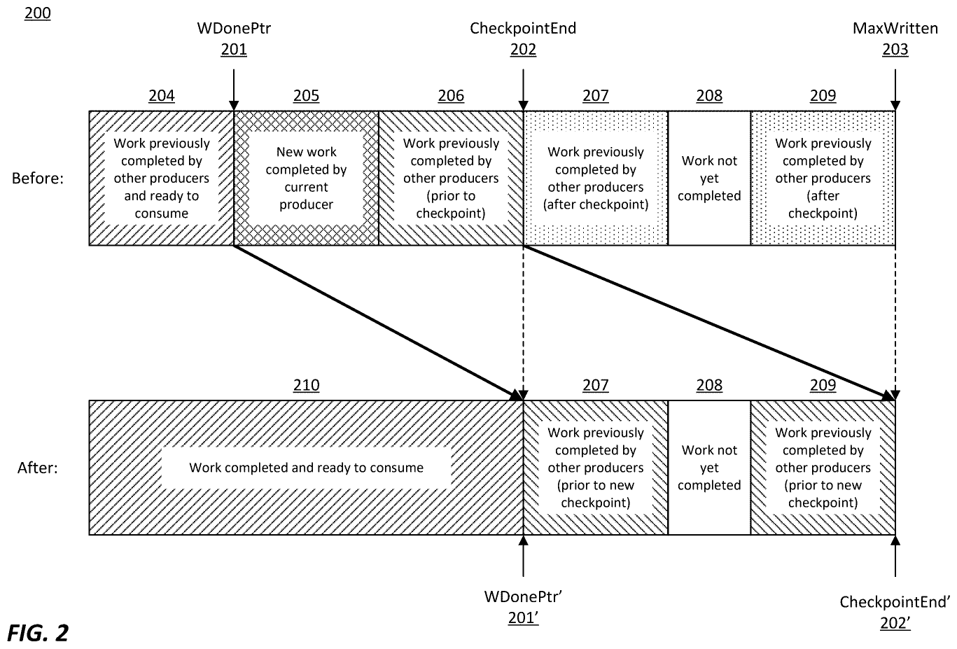

FIG. 2 illustrates an example 200 of updating a write-done pointer and a checkpoint in a FIFO queue. Initially, example 200 shows that, before a checkpoint update by an atomic instruction, a FIFO queue includes a plurality of regions, including region(s) that store data corresponding to previously completed work (e.g., regions 204, 206, 207, and region 209), region(s) that store data corresponding to work completed by the current producer (e.g., region 205), and region(s) that store data corresponding to not completed work (e.g., region 208). A plurality of pointers (e.g., queue offsets) are associated with the FIFO queue, including a WDonePtr 201, a CheckpointEnd 202, and a MaxWritten 203.

Example 200 also shows that, after a checkpoint update (e.g., by an atomic instruction), the value of WDonePtr 201 has been updated (WDonePtr′ 201′) to correspond to the prior value of CheckpointEnd 202. Additionally, the value of CheckpointEnd 202 has been updated (CheckpointEnd′ 202′) to correspond to the value of MaxWritten 203. As a result of the value of WDonePtr′ 201′, the entire region prior to the pointer is considered to store data corresponding to previously completed work (e.g., region 210, corresponding to prior regions 204-206).

In embodiments, the atomic instruction calculates temporary values, referred to herein as isPrBeforeCheckpoint, newCountBeforeOldCp, isCheckpointDone, isAllDone, newMaxWritten, and newCountTotal.

In embodiments, isBeforeCheckpoint is a Boolean value, which the atomic instruction sets to True if the value of PrEnd is less than, or equal to, the value of CheckpointEnd, and False otherwise. Thus, in embodiments, isBeforeCheckpoint is calculated as:

$$bool isBeforeCheckpoint = ( PrEnd <= CheckpointEnd )$$

In embodiments, newCountBeforeOldCp (which counts the number of completed data items located prior to the current checkpoint) is an integer value, which the atomic instruction sets to the value of CpCountWritten if isBeforeCheckpoint is False, or sets to the sum of CpCountWritten and PrCount, if isBeforeCheckpoint is True. Thus, in embodiments, newCountBeforeOldCp may be calculated using a ternary conditional operator, as follows:

$$newCountBeforeOldCp = isBeforeCheckpoint ? CpCountWritten + PrCount : CpCountWritten$$

In embodiments, isCheckpointDone (is checkpoint done?) is a Booelan value, which the atomic instruction sets to False if newCountBeforeOldCp equals CheckpointEnd, or otherwise sets to False. Thus, in embodiments, isCheckpointDone may be calculated using a ternary conditional operator, as follows:

$$bool isCheckpointDone = ( ( newCountBeforeOldCp == CheckpointEnd ) ? true : false )$$

In embodiments, newMaxWritten (new max written) is an integer value, which the atomic instruction sets to the maximum of MaxWritten or PrEnd. Thus, in embodiments, newMaxWritten is calculated as:

$$newMaxWritten = Max ( MaxWritten , PrEnd )$$

In embodiments, newCountTotal (new count total) is an integer value, which the atomic instruction sets to the sum of CountTotal and PrCount. Thus, in embodiments, newCountTotal is calculated as:

$$newCountTotal = CountTotal + PrCount$$

In embodiments, isAllDone (is All Done) is a Boolean value, indicating whether all work up to the New Max Written has been completed. Thus, in embodiments, isAllDone may be calculated using a ternary conditional operator, as follows:

$$bool isAllDone = ( newCountTotal == newMaxWritten ) ? true : false$$

Based on calculating these temporary values, the atomic instruction updates the four values in memory as follows:

| | |
|---|---|
| 1. | If isCheckpointDone is true, then: |
| | CheckpointEnd is set equal to newMaxWritten |
| | CpCountWritten is set equal to newCountTotal |
| | Else |
| | CheckpointEnd remains the same |
| | CpCountWritten is set equal to newCountBeforeOldCp |
| 2. | Update MaxWritten and CountTotal as calculated |

In embodiments, the atomic instruction performs these calculations at least partially in parallel. Notably, in some embodiments, CpCountWritten could be replaced with a count of entries remaining for that checkpoint, with some different intermediate calculations.

In some embodiments, the atomic instruction returns, to the producer/caller, the previous memory contents (e.g., the original four values of MaxWritten, CountTotal, CheckpointEnd, and CpCountWritten). These embodiments of the atomic instruction are referred to herein as a “four-word atomic instruction.” In these embodiments, the producer recreates the operations from the four-word atomic instruction and updates a WDonePtr for the FIFO queue (e.g., in memory, in a register). In embodiments, the new value WDonePtr, or newWDonePtr, is calculated as:

```
If isAllDone
  newWDonePtr = NewMaxWritten
Else If isCpDone && isBeforeCp
  # the checkpoint has been reached
  newWDonePtr = CheckpointEnd
```

In embodiments, when the producer receives or recalculates isCheckpointDone and WDonePtr, it atomically adjusts WDonePtr in memory, e.g., with an atomic maximum (max) operation.

In some embodiments, the producer also increments (e.g., with an atomic “add” instruction) a count of data items available to read (e.g., by consumers), with the count being incremented with a difference between the old and new values of the WDonePtr.

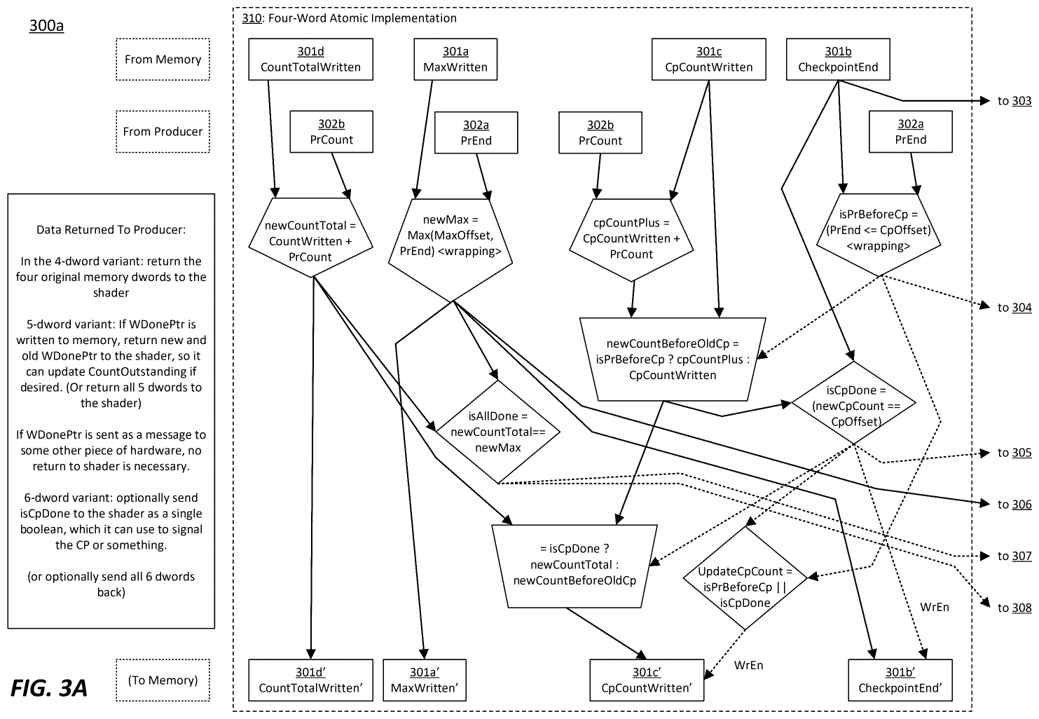

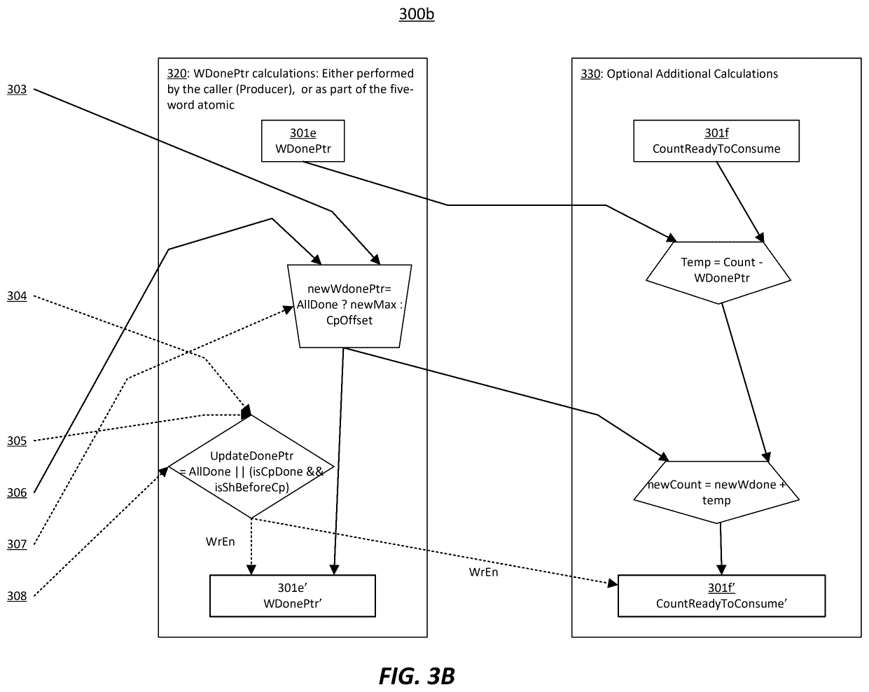

Referring to FIG. 3A, a four-word atomic instruction (box 310) reads four values from memory, including CountTotalWritten 301d, MaxWritten 301a, CpCountWritten 301c, and CheckpointEnd 301b. The four-word atomic instruction also receives two values from the caller (a producer, such as a GPU shader), including PrEnd 302a and PrCount 302b. The four-word atomic instruction calculates new values for the memory locations that were read and updates those memory locations—illustrated as CountTotalWritten′ 301d′, MaxWritten′ 301a′, CpCountWritten′ 301c′, and CheckpointEnd′ 301b′.

Referring to FIG. 3B, box 320 shows that the four-word atomic instruction also calculates and updates WDonePtr 301e, with the updated value illustrated as WDonePtr′ 301e′. In various embodiments, WDonePtr′ 301e′ is written as a fifth value (e.g., memory or register) or is sent as a message to a component (e.g., hardware) listening for updates to the FIFO queue. In embodiments, if WDonePtr′ 301e′ is written to memory, an atomic instruction (e.g., a five-word atomic instruction) returns the new WDonePtr (WDonePtr′ 301e′) and the old WDonePtr (WDonePtr 301e) to the caller. In embodiments, no return to the producer may be needed if WDonePtr′ 301e′ is sent as a message to another component, or if another component polls the value of WDonePtr in memory.

Other embodiments may implement a six-word atomic instruction that returns isCheckpointDone, or the old WDonePtr (WDonePtr 301e) and the new WDonePtr (WDonePtr′ 301e′). In some embodiments, the six-word atomic instruction updates an UnconsumedDataCount (count of unconsumed data) as follows:

If (isAllDone | | (isCpDone && isBeforeCp))
UnconsumedDataCount += NewWDonePtr − OldWDonePtr

In other embodiments, the producer updates UnconsumedDataCount as a separate operation. FIG. 3B illustrates one example (box 330) of the additional calculations performed in one embodiment of a six-word atomic instruction, including the derivation of a value 301f′ (CountReadyToConsume′) from an original value 301f (CountReadyToConsume), based on the old and new values of WDonePtr (301e and 301e′)

Notably, while each example atomic instruction (e.g., the four-word, five-word, and six-word variants) is described herein as a single atomic instruction, some embodiments may implement each as two or more atomic instructions.

Notably, the atomic instruction(s) described herein is operable whether the FIFO queue is fixed or variable in size (e.g., growable).

Additionally, in embodiments, the atomic instruction(s) described herein handle wrapping, e.g., in the case in which a FIFO queue is implemented as a circular buffer. In these embodiments, each greater-than/less-than comparison and maximum (max) operation are treated as a “wrapping comparison.” That is to say, if the values have B bits (e.g., a 32-bit word), and one value is more than 2\hat{ }(B−1) larger than the other value, the smaller value is treated as if it were 2\hat{ }B larger than it currently is (e.g., implying that it has wrapped the size of the FIFO queue), and comparison is calculated with that adjusted value.

Notably, a wrapping comparison avoids special handling as the MaxWritten, CpCountWritten, and CheckpointEnd values approach the maximum value of the size of an “unsigned word” for the system.

In embodiments, this wrapping max operation between MaxWritten (301a) and PrEnd (302a) can be implemented as:

$$newMax = ( ( MaxWritten - PrEnd ) ≫ ( B - 1 ) ) ? PrEnd : MaxWritten .$$

Or, in another embodiment, it can be implemented as:

$$newMax = ( ( MaxWritten [ B - 2 : 0 ] >= PrEnd [ B - 2 : 0 ] ) \hat{} MaxWritten [ B - 1 ] \hat{} PrEnd [ B - 1 ] ? MaxWritten : PrEnd .$$

In embodiments, this wrapping comparison of CheckpointEnd (301b) with PrEnd (302a) can be implemented as:

$$isBeforeCp = ( ( CheckpointEnd [ B - 2 : 0 ] >= PrEnd [ B - 2 : 0 ] ) \hat{} CheckpointEnd [ B - 1 ] \hat{} PrEnd [ B - 1 ] ? true : false .$$

Or, in another embodiment, it can be implemented as:

$$isBeforeCp = ( ( CheckpointEnd - PrEnd ) ≫ ( B - 1 ) ) ? false : true .$$

A FIFO queue's size may be considerably smaller than the max value that can be held in the system's unsigned word size. If the FIFO queue is a circular buffer, which can hold exactly a power-of-two number of elements (e.g., size=2\hat{ }N), then the location of WDonePtr within the buffer can be calculated simply by masking the high bits, e.g., (WDonePtr & ((2\hat{ }N)−1)).

FIGS. 3A and 3B include various intermediary operations for calculating values 301a′-301f′. It is noted that these are one example only and that various intermediary operations could be used to arrive at the same result. The particular choice of intermediary operations may be based on factors such as available silicon die area or desired signal propagation timing characteristics.

In various embodiments, the atomic instruction(s) can be implemented either directly in hardware or as part of a programmable atomic (such as an atomic shader or some other method of instructing the hardware on the details of which math and comparison operations to perform as part of an atomic.)

Notably, some embodiments coalesce multiple requests from different producers to different portions of the same cache line into a single cache line-aligned request, and then a single producer calls the atomic instruction.

In situations where multiple producers are working together (such as a wave of shader threads), where the producers operate on the same FIFO queue, and where the producers' allocations in the queue are contiguous, the producers may coalesce their requests, such that only one request is sent to the atomic instruction, with a PrMax (producer max) equal to the maximum of all the producers' PrMax values, and a PrCount is equal to the sum of all the grouped requestors' PrCount values.

In embodiments, the atomic instruction described herein can also be used for multi-consumer scenarios, using different variables but with analogous math and setup. These multi-consumer scenarios include, as examples, requesting a portion of a FIFO queue to read, reading the data from the FIFO queue, ensuring the consumer has fully consumed the data and is not re-reading it, and/or updating a RDonePtr (“read done” pointer) indicating that all data up to that point has been read and, therefore, that portion of the FIFO can be reused by future producers.

While the embodiments herein have focused on atomic instructions implemented at a GPU, it is noted that the atomic instructions discussed herein could alternatively be implemented in a system-on-a-chip (SOC), or as a system-level (SOC-level) atomic instruction. Additionally, the atomic instructions discussed herein could be implemented on a CPU as a series of transactional memory instructions (e.g., if memory 103 is transactional memory) or a compare-exchange instruction, or on a neural processing unit (NPU) or tensor processing unit (TPU).

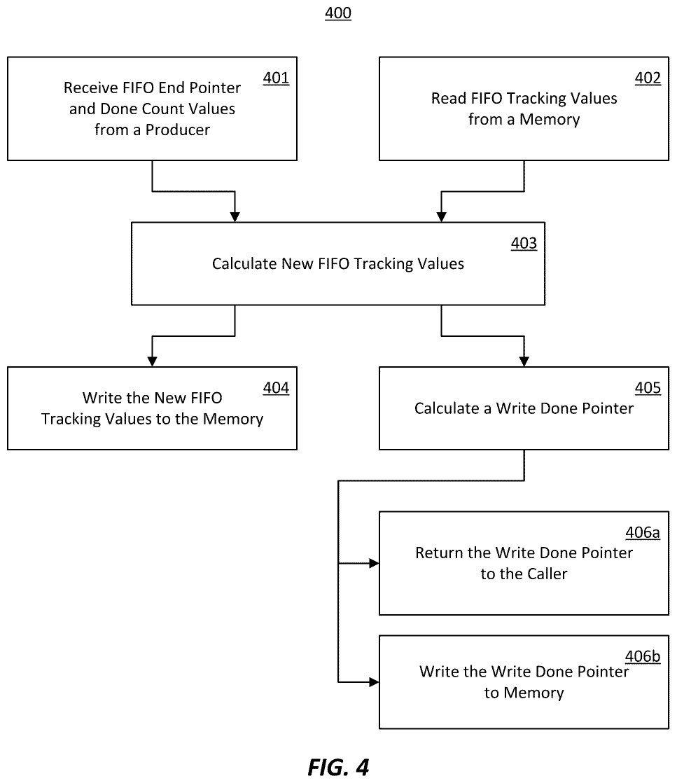

Embodiments are now described in connection with FIG. 4, which illustrates a flow chart of an example method 400 for updating a write-done pointer in a first-in-first-out queue on a parallelized device. In some examples, method 400 is implemented as an atomic instruction, e.g., as part of CPU 107 or GPU 108. For example, the atomic instruction may be implemented as hardware logic, as a programmable atomic, or as a plurality of CPU instructions that atomically update the values in memory with transactional memory operations or a compare-exchange instruction.

The following discussion now refers to a method and method acts. Although the method acts are discussed in specific orders or are illustrated in a flow chart as occurring in a particular order, no order is required unless expressly stated or required because an act is dependent on another act being completed prior to the act being performed.

Referring to FIG. 4, in embodiments, method 400 comprises act 401 of receiving FIFO end pointer and done count values from a producer. In some embodiments, act 401 comprises receiving a plurality of values from a producer, including receiving an end pointer value (e.g., PrEnd) representing a pointer to an end of data the producer has finished writing into a FIFO queue, and receiving a done count value (e.g., PrCount) indicating a number of data items the producer has finished writing into the FIFO queue. In one example, referring to FIG. 3A, an atomic instruction receives, from a caller (e.g., producer, such as a GPU shader), PrEnd 302a and PrCount 302b.

Method 400 also comprises act 402 of reading FIFO tracking values from a memory. In some embodiments, act 402 comprises reading a plurality of memory values from a plurality of memory locations. In embodiments, to facilitate the implementation of an atomic instruction, these memory locations are contiguous within memory. In embodiments, act 402 includes reading a checkpoint value (e.g., CheckpointEnd) from a first memory location, the checkpoint value indicating a checkpoint location in the FIFO queue. In embodiments, act 402 includes reading a checkpoint write count value (e.g., CpCountWritten) from a second memory location, the checkpoint write count value indicating a count of data items before the checkpoint location that have each been written and marked complete by any producer. In embodiments, act 402 includes reading a max written value (e.g., MaxWritten) from a third memory location, the max written value indicating an offset of a furthest location written to in the FIFO queue. In embodiments, act 402 includes reading a count total value (e.g., CountTotal) from a fourth memory location, the count total value indicating a total number of data items written to the FIFO queue. In one example, referring to FIG. 3A, a four-word atomic instruction reads, from a memory, MaxWritten 301a, CheckpointEnd 301b, CpCountWritten 301c, and CountTotalWritten 301d.

Method 400 also comprises act 403 of calculating new FIFO tracking values. In some embodiments, act 403 comprises based on the end pointer value and the done count value, calculating a new checkpoint value, a new checkpoint write count value, a new max written value, and a new count total value. The particular manner of calculating these values can vary, but examples are provided in FIGS. 3A-3B. In general, however, the calculations include calculating the new count total value to be the sum of the count total value (e.g., CountTotal) and the done count value (e.g., PrCount), and calculating the new max written value to be the maximum of the max written value (e.g., CpCountWritten) and the end pointer value (e.g., PrEnd). When the end pointer value (e.g., PrEnd) is less than or equal to the checkpoint value (e.g., CheckpointEnd), the new checkpoint write count value is calculated to be the sum of the done count value (e.g., PrCount) and the end pointer value (e.g., PrEnd). When all work in the FIFO queue prior to the checkpoint location in the FIFO queue indicated by the checkpoint value (e.g., CheckpointEnd) is completed (e.g., when new CpCountWritten is equal to CheckpointEnd), the new checkpoint value receives the new max written value, and the new checkpoint write count value receives the new count total value.

In some embodiments, the FIFO queue is a circular buffer, and calculating one or more of the checkpoint value, the checkpoint write count value, the max written value, or the count total value comprises using a wrapping comparison for a greater-than operation, a less-than operation, or a maximum operation.

Method 400 also comprises act 404 of writing the new FIFO tracking values to the memory. In some embodiments, act 404 comprises updating the plurality of values in the memory, including updating the first memory location with the new checkpoint value, updating the second memory location with the new checkpoint write count value, updating the third memory location with the new max written value, and updating the fourth memory location with the new count total value. In one example, referring to FIG. 3A, a four-word atomic instruction writes, from a memory, MaxWritten′ 301a′, CheckpointEnd′ 301b′, CpCountWritten′ 301c′, and CountTotalWritten′ 301d′. Notably, in some situations, a particular value may remain unchanged after act 403. In these embodiments, updating that value in memory may be a no-op, e.g., no memory write actually occurs.

In some implementations, an atomic instruction may also return the original values to the caller. Thus, some embodiments of act 404 further comprise returning, to the caller/producer, one or more of the checkpoint value, the checkpoint write count value, the max written value, or the count total value.

As mentioned, one goal of the atomic instruction is to facilitate the calculation of a new WDonePtr. In some embodiments, the producer/caller calculates the new WDonePtr, based on the four old values in memory, and the producer then writes the new WDonePtr to memory (e.g., using an atomic Max operation).

In other embodiments, the atomic operation calculates the new WDonePtr. After calculating the new WDonePtr, the atomic operation may return the new WDonePtr to producer/caller. Additionally, or alternatively, the atomic operation may update the old WDonePtr with the new WDonePtr in memory. In embodiments, if the atomic operation only returns the new WDonePtr to the producer/caller and does not update it in memory, the producer/caller may update it in memory (e.g., using an atomic Max operation). In embodiments, if the atomic operation updates the WDonePtr in memory, the atomic operation may also return the old and new WDonePtrs to the producer/caller.

In some embodiments, method 400 also comprises act 405 of calculating a write done pointer. In some embodiments, act 405 comprises determining a new write done pointer to be the new max written value when the new max written value is equal to the new count total value, or the checkpoint value when work before the checkpoint is complete, and the producer end pointer value is less-than-or-equal-to the checkpoint value. For example, referring to FIG. 3B, an atomic instruction calculates WDonePtr′ 301e′. In some embodiments, act 405 also includes incrementing a count of unconsumed data by a difference between the new write done pointer and a prior write done pointer.

In some embodiments, method 400 also comprises act 406a of returning the write done pointer. In some embodiments, act 406a comprises returning the new write done pointer to a caller. For example, referring to FIG. 3B, the atomic instruction returns WDonePtr′ 301e′ to the caller. In some embodiments, act 406a also comprises returning the prior write done pointer to the caller.

Additionally, or alternatively, in some embodiments, method 400 also comprises act 406b of writing the write done pointer to memory. In some embodiments, act 406b comprises writing the write done pointer to a memory location. For example, referring to FIG. 3B, the atomic instruction writes WDonePtr′ 301e′ to memory, e.g., overwriting WDonePtr 301e.

In some embodiments, method 400 may comprise sending the write done pointer to a hardware consumer.

As mentioned, some embodiments may include six-word atomic instruction that returns isCheckpointDone, or that returns the old and new WDonePtr. In these embodiments, the six-word atomic instruction may update a count of unconsumed data by a difference between a newly-calculated WDonePtr (e.g., as calculated in act 405) and a prior WDonePtr.

Notably, additional variations can exist. In one example, some embodiments may support more than one checkpoint. In one example, when MaxWritten updates, if one of the checkpoints is completed and the other is not, the completed receives the value of the new MaxWritten, and the new WDonePtr is calculated to be the location of the furthest completed checkpoint. In another example, if both checkpoints are completed, one checkpoint can receive the value of the new MaxWritten, and the other can receive a location equal to the new MaxWritten plus some constant value. In most cases, this will increase the frequency that the WDonePtr is updated, which may be beneficial to cache coherency of the FIFO queue's contents between production and consumption.

In another example, it is noted that the five values stored in memory (e.g., MaxWritten, CountTotal, CheckpointEnd, CpCountWritten, and WDonePtr) may have different sizes. For example, CheckpointEnd may be one bit larger than CpCountWritten, and MaxWritten may be one bit larger than CountTotal. If this is the case, equality comparisons by the atomic instruction may ignore a high bit. In another example, WDonePtr may be one or more bits larger than CheckpointEnd or MaxWritten. If this is the case, the mismatched bits in WDonePtr increment by one whenever the highest matched bit changes from one to zero. These mismatched bit sizes are useful for packing the five values within the memory that is natively fetched by hardware executing the atomic instruction, conserving memory use and potentially increasing memory read and write speeds.

Alternatively or in addition to the other examples described herein, examples include any combination of the following:

Clause 1. A method, implemented in a computer system that includes a processor system, comprising: receiving a plurality of values from a producer, including: receiving an end pointer value (PrEnd) representing a pointer to an end of data the producer has finished writing into a first-in-first-out (FIFO) queue, and receiving a done count value indicating a number of data items the producer has finished writing into the FIFO queue; reading a plurality of memory values from a plurality of memory locations in a memory, including: reading a checkpoint value from a first memory location, the checkpoint value indicating a checkpoint location in the FIFO queue, reading a checkpoint write count value from a second memory location, the checkpoint write count value indicating a count of data items before the checkpoint location that have each been written and marked complete by any producer, reading a max written value from a third memory location, the max written value indicating an offset of a furthest location written to in the FIFO queue, and reading a count total value from a fourth memory location, the count total value indicating a total number of data items written to the FIFO queue; calculating a new checkpoint value, a new checkpoint write count value, a new max written value, and a new count total value, wherein: the new count total value is calculated as a sum of the count total value and the done count value; the new max written value is calculated as a maximum of the max written value and the end pointer value; when the end pointer value is less than the checkpoint value, the new checkpoint write count value is calculated as a sum of the done count value and the checkpoint write count value; or when all work in the FIFO queue prior to the checkpoint location in the FIFO queue indicated by the checkpoint value is completed (e.g., when the new checkpoint write count value is equal to the checkpoint value), the new checkpoint value receives the new max written value and the new checkpoint write count value receives the new count total value; and updating the plurality of memory locations in the memory, including updating the first memory location with the new checkpoint value, updating the second memory location with the new checkpoint write count value, updating the third memory location with the new max written value, and updating the fourth memory location with the new count total value.

Clause 2. The method of clause 1, wherein the method is performed as an atomic instruction, and the atomic instruction is implemented as hardware logic, as a programmable atomic, or as a plurality of central processing unit instructions that atomically update the plurality of memory locations with transactional memory operations or a compare-exchange instruction.

Clause 3. The method of clause 1, wherein the method further comprises returning, to the producer, one or more of the checkpoint value, the checkpoint write count value, the max written value, or the count total value.

Clause 4. The method of clause 1, wherein the FIFO queue is a circular buffer, and calculating one or more of the checkpoint value, the checkpoint write count value, the max written value, or the count total value comprises using a wrapping comparison for a greater-than operation, a less-than operation, or a maximum operation.

Clause 5. The method of clause 1, wherein the method further comprises determining a new write done pointer to be: the new max written value when the new max written value is equal to the new count total value; or the checkpoint value when all work prior to the checkpoint location has been completed, and the end pointer value is less-than-or-equal-to the checkpoint value.

Clause 6. The method of clause 5, wherein the method further comprises returning at least one of a prior write done pointer or the new write done pointer to the producer.

Clause 7. The method of clause 5, wherein the method further comprises sending, to a hardware consumer, at least one of a prior write done pointer, the new write done pointer, a signal indicating that a write done pointer has been updated, or a signal indicating completion of a checkpoint.

Clause 8. The method of clause 5, wherein the method further comprises writing the write done pointer to the memory.

Clause 9. The method of clause 5, wherein the method further comprises incrementing a count of unconsumed data by a difference between the new write done pointer and a prior write done pointer.

Clause 10. A processor system that includes an atomic instruction that, when executed: receives an end pointer value from a producer, the end pointer value representing a pointer to an end of data the producer has finished writing into a first-in-first-out (FIFO) queue; receives a done count value from the producer, the done count value indicating a number of data items the producer has finished writing into the FIFO queue; reads a plurality of values from a memory, including: reading a checkpoint value from a first memory location, the checkpoint value indicating a checkpoint location in the FIFO queue, reading a checkpoint write count value from a second memory location, the checkpoint write count value indicating a count of data items before the checkpoint location that have each been written and marked complete by any producer, reading a max written value from a third memory location, the max written value indicating an offset of a furthest location written to in the FIFO queue, and reading a count total value from a fourth memory location, the count total value indicating a total number of data items written to the FIFO queue; calculates a new checkpoint value, a new checkpoint write count value, a new max written value, and a new count total value, wherein: the new count total value is calculated as a sum of the count total value and the done count value; the new max written value is calculated as a maximum of the max written value and the end pointer value; when the end pointer value is less than the checkpoint value, the new checkpoint write count value is calculated as a sum of the done count value and the checkpoint write count value; or when all work in the FIFO queue prior to the checkpoint location in the FIFO queue indicated by the checkpoint value is completed, the new checkpoint value receives the new max written value and the new checkpoint write count value receives the new count total value; and updates the memory, including updating the first memory location with the new checkpoint value, updating the second memory location with the new checkpoint write count value, updating the third memory location with the new max written value, and updating the fourth memory location with the new count total value.

Clause 11. The processor system of clause 10, wherein the atomic instruction is implemented as hardware logic, as a programmable atomic, or as a plurality of central processing unit instructions that atomically update the plurality of memory locations with transactional memory operations or a compare-exchange instruction.

Clause 12. The processor system of clause 10, wherein the atomic instruction returns one or more of the checkpoint value, the checkpoint write count value, the max written value, or the count total value.

Clause 13. The processor system of clause 10, wherein the FIFO queue is a circular buffer, and calculating one or more of the checkpoint value, the checkpoint write count value, the max written value, or the count total value comprises using a wrapping comparison for a greater-than operation, a less-than operation, or a maximum operation.

Clause 14. The processor system of clause 10, wherein the atomic instruction determines a new write done pointer to be: the new max written value when the new max written value is equal to the new count total value; or the checkpoint value when all work prior to the checkpoint location is complete, and the end pointer value is less-than-or-equal-to the checkpoint value.

Clause 15. The processor system of clause 14, wherein the atomic instruction returns at least one of a prior write done pointer or the new write done pointer to the producer.

Clause 16. The processor system of clause 14, wherein the atomic instruction sends, to a hardware consumer, at least one of a prior write done pointer, the new write done pointer, a signal indicating that a value of a write done pointer has changed, or a signal indicating completion of a checkpoint.

Clause 17. A computer system, comprising: a memory; and a processor system that includes an atomic instruction that, when executed: receives an end pointer value from a producer, the end pointer value representing a pointer to an end of data the producer has finished writing into a first-in-first-out (FIFO) queue; receives a done count value from the producer, the done count value indicating a number of data items the producer has finished writing into the FIFO queue; reads a checkpoint value from a first memory location, the checkpoint value indicating a checkpoint location in the FIFO queue; reads a checkpoint write count value from a second memory location, the checkpoint write count value indicating a count of data items before the checkpoint location that have each been written and marked complete by any producer; reads a max written value from a third memory location, the max written value indicating an offset of a furthest location written to in the FIFO queue; reads a count total value from a fourth memory location, the count total value indicating a total number of data items written to the FIFO queue; calculates a new checkpoint value, a new checkpoint write count value, a new max written value, and a new count total value, wherein: the new count total value is calculated as a sum of the count total value and the done count value; the new max written value is calculated as a maximum of the max written value and the end pointer value; when the end pointer value is less than the checkpoint value, the new checkpoint write count value is calculated as a sum of the done count value and the checkpoint write count value; or when all work in the FIFO queue prior to the checkpoint location in the FIFO queue indicated by the checkpoint value is completed, the new checkpoint value receives the new max written value and the new checkpoint write count value receives the new count total value; updates the first memory location with the new checkpoint value; updates the second memory location with the new checkpoint write count value; updates the third memory location with the max written value; and updates the fourth memory location with the count total value.

Clause 18. The computer system of clause 17, wherein the atomic instruction also calculates a write done pointer and returns the write done pointer to a caller.

Clause 19. The computer system of clause 17, wherein the atomic instruction also calculates a write done pointer and writes the write done pointer to the memory.

Clause 20. The computer system of clause 17, wherein the atomic instruction also returns, to the producer, one or more of the checkpoint value, the checkpoint write count value, the max written value, or the count total value.

Embodiments of the disclosure comprise or utilize a special-purpose or general-purpose computer system (e.g., computer system 101) that includes computer hardware, such as, for example, a processor system (e.g., one or more processor system 102) and system memory (e.g., memory 103), as discussed in greater detail below. Embodiments within the scope of the present disclosure also include physical and other computer-readable media (e.g., storage medium 104) for carrying or storing computer-executable instructions and/or data structures. Such computer-readable media can be any available media accessible by a general-purpose or special-purpose computer system. Computer-readable media that store computer-executable instructions and/or data structures are computer storage media. Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 105) and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system (e.g., one or more processor system 102) comprises one or more CPUs (e.g., CPU 107), one or more GPUs (e.g., GPU 108), one or more NPUs, and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (Saas), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more virtual machines (VMs). During operation, VMs emulate an operational computing system, supporting an operating system (OS) and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method, implemented in a computer system that includes a processor system, comprising:
receiving a plurality of values from a producer, including:
receiving an end pointer value representing a pointer to an end of data the producer has finished writing into a first-in-first-out (FIFO) queue, and
receiving a done count value indicating a number of data items the producer has finished writing into the FIFO queue;
reading a plurality of memory values from a plurality of memory locations in a memory, including:
reading a checkpoint value from a first memory location, the checkpoint value indicating a checkpoint location in the FIFO queue,
reading a checkpoint write count value from a second memory location, the checkpoint write count value indicating a count of data items before the checkpoint location that have each been written and marked complete by any producer,
reading a max written value from a third memory location, the max written value indicating an offset of a furthest location written to in the FIFO queue, and
reading a count total value from a fourth memory location, the count total value indicating a total number of data items written to the FIFO queue;
calculating a new checkpoint value, a new checkpoint write count value, a new max written value, and a new count total value, wherein:
the new count total value is calculated as a sum of the count total value and the done count value;
the new max written value is calculated as a maximum of the max written value and the end pointer value;
when the end pointer value is less than the checkpoint value, the new checkpoint write count value is calculated as a sum of the done count value and the checkpoint write count value; or
when all work in the FIFO queue prior to the checkpoint location in the FIFO queue indicated by the checkpoint value is completed, the new checkpoint value receives the new max written value and the new checkpoint write count value receives the new count total value; and
updating the plurality of memory locations in the memory, including updating the first memory location with the new checkpoint value, updating the second memory location with the new checkpoint write count value, updating the third memory location with the new max written value, and updating the fourth memory location with the new count total value.

2. The method of claim 1, wherein the method is performed as an atomic instruction, and the atomic instruction is implemented as hardware logic, as a programmable atomic, or as a plurality of central processing unit instructions that atomically update the plurality of memory locations with transactional memory operations or a compare-exchange instruction.

3. The method of claim 1, wherein the method further comprises returning, to the producer, one or more of the checkpoint value, the checkpoint write count value, the max written value, or the count total value.

4. The method of claim 1, wherein the FIFO queue is a circular buffer, and calculating one or more of the checkpoint value, the checkpoint write count value, the max written value, or the count total value comprises using a wrapping comparison for a greater-than operation, a less-than operation, or a maximum operation.

5. The method of claim 1, wherein the method further comprises determining a new write done pointer to be:
the new max written value when the new max written value is equal to the new count total value; or
the checkpoint value when all work prior to the checkpoint location has been completed, and the end pointer value is less-than-or-equal-to the checkpoint value.

6. The method of claim 5, wherein the method further comprises returning at least one of a prior write done pointer or the new write done pointer to the producer.

7. The method of claim 5, wherein the method further comprises sending, to a hardware consumer, at least one of a prior write done pointer, the new write done pointer, a signal indicating that a write done pointer has been updated, or a signal indicating completion of a checkpoint.

8. The method of claim 5, wherein the method further comprises writing the new write done pointer to the memory.

9. The method of claim 5, wherein the method further comprises incrementing a count of unconsumed data by a difference between the new write done pointer and a prior write done pointer.

10. A processor system that includes an atomic instruction that, when executed:
receives an end pointer value from a producer, the end pointer value representing a pointer to an end of data the producer has finished writing into a first-in-first-out (FIFO) queue;
receives a done count value from the producer, the done count value indicating a number of data items the producer has finished writing into the FIFO queue;
reads a plurality of values from a memory, including:
reading a checkpoint value from a first memory location, the checkpoint value indicating a checkpoint location in the FIFO queue,
reading a checkpoint write count value from a second memory location, the checkpoint write count value indicating a count of data items before the checkpoint location that have each been written and marked complete by any producer,
reading a max written value from a third memory location, the max written value indicating an offset of a furthest location written to in the FIFO queue, and
reading a count total value from a fourth memory location, the count total value indicating a total number of data items written to the FIFO queue;
calculates a new checkpoint value, a new checkpoint write count value, a new max written value, and a new count total value, wherein:
the new count total value is calculated as a sum of the count total value and the done count value;
the new max written value is calculated as a maximum of the max written value and the end pointer value;
when the end pointer value is less than the checkpoint value, the new checkpoint write count value is calculated as a sum of the done count value and the checkpoint write count value; or
when all work in the FIFO queue prior to the checkpoint location in the FIFO queue indicated by the checkpoint value is completed, the new checkpoint value receives the new max written value and the new checkpoint write count value receives the new count total value; and
updates the memory, including updating the first memory location with the new checkpoint value, updating the second memory location with the new checkpoint write count value, updating the third memory location with the new max written value, and updating the fourth memory location with the new count total value.

11. The processor system of claim 10, wherein the atomic instruction is implemented as hardware logic, as a programmable atomic, or as a plurality of central processing unit instructions that atomically update the plurality of memory locations with transactional memory operations or a compare-exchange instruction.

12. The processor system of claim 10, wherein the atomic instruction returns one or more of the checkpoint value, the checkpoint write count value, the max written value, or the count total value.

13. The processor system of claim 10, wherein the FIFO queue is a circular buffer, and calculating one or more of the checkpoint value, the checkpoint write count value, the max written value, or the count total value comprises using a wrapping comparison for a greater-than operation, a less-than operation, or a maximum operation.

14. The processor system of claim 10, wherein the atomic instruction determines a new write done pointer to be:
the new max written value when the new max written value is equal to the new count total value; or
the checkpoint value when all work prior to the checkpoint location is complete, and the end pointer value is less-than-or-equal-to the checkpoint value.

15. The processor system of claim 14, wherein the atomic instruction returns at least one of a prior write done pointer or the new write done pointer to the producer.

16. The processor system of claim 14, wherein the atomic instruction sends, to a hardware consumer, at least one of a prior write done pointer, the new write done pointer, a signal indicating that a value of a write done pointer has changed, or a signal indicating completion of a checkpoint.

17. A computer system, comprising:
a memory; and
a processor system that includes an atomic instruction that, when executed:
receives an end pointer value from a producer, the end pointer value representing a pointer to an end of data the producer has finished writing into a first-in-first-out (FIFO) queue;
receives a done count value from the producer, the done count value indicating a number of data items the producer has finished writing into the FIFO queue;
reads a checkpoint value from a first memory location, the checkpoint value indicating a checkpoint location in the FIFO queue;
reads a checkpoint write count value from a second memory location, the checkpoint write count value indicating a count of data items before the checkpoint location that have each been written and marked complete by any producer;
reads a max written value from a third memory location, the max written value indicating an offset of a furthest location written to in the FIFO queue;
reads a count total value from a fourth memory location, the count total value indicating a total number of data items written to the FIFO queue;
calculates a new checkpoint value, a new checkpoint write count value, a new max written value, and a new count total value, wherein:
the new count total value is calculated as a sum of the count total value and the done count value;
the new max written value is calculated as a maximum of the max written value and the end pointer value;
when the end pointer value is less than the checkpoint value, the new checkpoint write count value is calculated as a sum of the done count value and the checkpoint write count value; or
when all work in the FIFO queue prior to the checkpoint location in the FIFO queue indicated by the checkpoint value is completed, the new checkpoint value receives the new max written value and the new checkpoint write count value receives the new count total value;
updates the first memory location with the new checkpoint value;
updates the second memory location with the new checkpoint write count value;
updates the third memory location with the max written value; and
updates the fourth memory location with the count total value.

18. The computer system of claim 17, wherein the atomic instruction also calculates a write done pointer and returns the write done pointer to a caller.

19. The computer system of claim 17, wherein the atomic instruction also calculates a write done pointer and writes the write done pointer to the memory.

20. The computer system of claim 17, wherein the atomic instruction also returns, to the producer, one or more of the checkpoint value, the checkpoint write count value, the max written value, or the count total value.
